(19) United States
(12) Patent Application Publication
(10) Pub. No.: US 2024/0007271 A1
(43) Pub. Date: Jan. 4, 2024

(54) IN-VEHICLE DEVICE, ENCRYPTED COMMUNICATION METHOD, AND ENCRYPTED COMMUNICATION PROGRAM

(71) Applicant: Sumitomo Electric Industries, Ltd., Osaka-shi, Osaka (JP)

(72) Inventors: Tatsushige INABA, Osaka-shi, Osaka (JP); Yoichi HATA, Osaka-shi, Osaka (JP)

(73) Assignee: Sumitomo Electric Industries, Ltd., Osaka-shi, Osaka (JP)

(21) Appl. No.: 18/032,812

(22) PCT Filed: Jul. 5, 2021
(86) PCT No.: PCT/JP2021/025351

§ 371 Date: Apr. 20, 2023

(30) Foreign Application Priority Data
Oct. 22, 2020 (JP) 2020-177070

(51) Int. Cl. H04L 9/08; H04L 9/32

(52) U.S. Cl. CPC H04L 9/0825; H04L 9/3242; H04L 9/0861

(57) ABSTRACT

An in-vehicle device to be mounted in a vehicle, includes: a processing unit configured to generate first key deriving information according to a first scheme, generate first key information by using the first key deriving information, and encrypt a packet by using the first key information; and a communication unit configured to transmit the packet encrypted by the processing unit to another vehicle. After encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

### TECHNICAL FIELD

The present disclosure relates to an in-vehicle device, an encrypted communication method, and an encrypted communication program.

This application claims priority on Japanese Patent Application No. 2020-177070 filed on Oct. 22, 2020, the entire content of which is incorporated herein by reference.

### BACKGROUND ART

NON-PATENT LITERATURE 1 (“Security for Connected Car”, Keisuke TAKEMORI, International Association of Traffic and Safety Sciences (IATSS) Review, Vol. 42, No. 2, 2017) discloses an in-vehicle network system as follows. That is, an in-vehicle network system in which communication data is encrypted with a key when a travel log of a vehicle is uploaded to a server, for example, is disclosed.

### CITATION LIST

### Non-Patent Literature

NON-PATENT LITERATURE 1: “Security for Connected Car”, Keisuke TAKEMORI, International Association of Traffic and Safety Sciences (IATSS) Review, Vol. 42, No. 2, 2017

### SUMMARY OF THE INVENTION

An in-vehicle device according to the present disclosure is an in-vehicle device to be mounted in a vehicle, and includes: a processing unit configured to generate first key deriving information according to a first scheme, generate first key information by using the first key deriving information, and encrypt a packet by using the first key information; and a communication unit configured to transmit the packet encrypted by the processing unit to another vehicle. After encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

An encrypted communication method according to the present disclosure is an encrypted communication method in an in-vehicle device to be mounted in a vehicle, and includes: generating first key deriving information according to a first scheme, generating first key information by using the first key deriving information, and encrypting a packet by using the first key information; transmitting the encrypted packet to another vehicle; and, after encrypting the packet by using the first key information, generating second key deriving information according to a second scheme that has a key information generating time shorter than that of the first scheme, generating second key information by using the second key deriving information, and encrypting a packet to be newly transmitted, by using the second key information instead of the first key information.

An encrypted communication program according to the present disclosure is an encrypted communication program used in an in-vehicle device to be mounted in a vehicle, and causes a computer to function as: a processing unit configured to generate first key deriving information according to a first scheme, generate first key information by using the first key deriving information, and encrypt a packet by using the first key information; and a communication unit configured to transmit the packet encrypted by the processing unit to another vehicle. After encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

An aspect of the present disclosure can be realized not only as an in-vehicle device that includes such a characteristic processing unit, but also as an in-vehicle communication system including in-vehicle devices. Another aspect of the present disclosure can be realized as a semiconductor integrated circuit that realizes a part or all of the in-vehicle device.

### BRIEF DESCRIPTION OF DRAWINGS

FIG. 1 shows a configuration of a vehicle management system according to an embodiment of the present disclosure.

FIG. 2 shows a configuration of an in-vehicle communication system according to the embodiment of the present disclosure.

FIG. 3 shows a configuration of an in-vehicle device in the in-vehicle communication system according to the embodiment of the present disclosure.

FIG. 4 shows a configuration of a processing unit in the in-vehicle device according to the embodiment of the present disclosure.

FIG. 5 shows a first half of a sequence indicating a process for encrypted communication in the vehicle management system according to the embodiment of the present disclosure.

FIG. 6 shows a second half of the sequence indicating the process for encrypted communication in the vehicle management system according to the embodiment of the present disclosure.

### DETAILED DESCRIPTION

Conventionally, development of security for an in-vehicle network system in a connected car connectable to the Internet, has been progressed.

### Problems to be Solved by the Present Disclosure

A technology capable of improving security, speed, stability, and the like of communication of an in-vehicle network system is desired beyond the technology described in NON-PATENT LITERATURE 1.

The present disclosure has been made in order to solve the above problem. An object of the present disclosure is to provide an in-vehicle device, an encryption method, and a program capable of providing more satisfactory communication in an in-vehicle network.

### Effects of the Present Disclosure

According to the present disclosure, more satisfactory communication can be provided in an in-vehicle network.

### Description of Embodiment of the Present Disclosure

First, contents of the embodiment of the present disclosure are listed and described.
(1) An in-vehicle device according to an embodiment of the present disclosure is an in-vehicle device to be mounted in a vehicle, and includes: a processing unit configured to generate first key deriving information according to a first scheme, generate first key information by using the first key deriving information, and encrypt a packet by using the first key information; and a communication unit configured to transmit the packet encrypted by the processing unit to another vehicle. After encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

In the above configuration, since each vehicle generates key information and uses the key information for packet encryption, each vehicle need not use and manage, over a long period of time, unique keys stored therein in advance. Furthermore, for example, since an encryption scheme having rather high security is used first and then the scheme is switched to an encryption scheme having a short generation time, encrypted communication can be effectively performed according to the features of the respective schemes. Therefore, more satisfactory communication can be provided in the in-vehicle network.
(2) The processing unit may encrypt the second key deriving information by using the first key information, and the communication unit may transmit, to the other vehicle, the second key deriving information encrypted by the processing unit.

In the above configuration, for example, the second key deriving information can be transmitted to the other vehicle by using the first scheme having high security, and encrypted communication using the second scheme having the short generation time can be started while ensuring security through a simple process.
(3) In the first scheme, the processing unit may generate a pair of a secret key and a public key as the first key deriving information, and generate a common key as the first key information by using the pair. In the second scheme, the processing unit may generate a hash value as the second key deriving information by using a first cryptographic hash function, and generate a common key from the hash value by using a second cryptographic hash function. The communication unit may transmit, to the other vehicle, the hash value generated by the processing unit.

The common key using the cryptographic hash function can be generated more quickly than the pair of the secret key and the public key. Therefore, data can be encrypted in a short time, whereby more encrypted packets can be exchanged in vehicle-to-vehicle communication.
(4) When a predetermined condition has been satisfied, the processing unit may generate the second key information, and use the second key information, instead of the first key information, for encryption of a packet to be newly transmitted by the communication unit. The predetermined condition is a condition regarding an elapsed time, or a communication traffic with the other vehicle from start of use of the first key information.

In the above configuration, switching from encrypted communication using the first key information to encrypted communication using the second key information can be performed at an appropriate timing.
(5) When a predetermined condition has been satisfied, the processing unit may generate the second key information, and use the second key information, instead of the first key information, for encryption of a packet to be newly transmitted by the communication unit. The predetermined condition may be a condition regarding a traveling state of the vehicle.

In the above configuration, for example, switching from encrypted communication using the first key information to encrypted communication using the second key information can be performed at an appropriate timing, according to a difference in speed between the vehicle and the other vehicle, i.e., a change in distance between the vehicles.
(6) The processing unit may update the second key information.

In the above configuration, even if encrypted communication using the second key information is intercepted and decrypted, since updated second key information can be used for subsequent encrypted communication, it is possible to reduce the risk that the encrypted communication is decrypted. Furthermore, security of the encrypted communication can be further improved by repeatedly updating the second key information having the short generation time. Moreover, when the second key information is generated upon satisfying the predetermined condition, the second key information can be updated at an appropriate timing according to the predetermined condition.
(7) In at least one of the first scheme and the second scheme, the processing unit may use time information and random numbers for generation of key deriving information.

By using the time information, the key deriving information can be changed with a lapse of time. If the key deriving information is generated by simply using only the time information, there is a risk that the time information is estimated and the key deriving information is decrypted. However, since the random numbers are used in addition to the time information, decryption of the key deriving information is inhibited even if the time information is estimated. Therefore, security of encrypted communication can be further improved.
(8) The processing unit may decrypt an encrypted packet received from the other vehicle, according to the first scheme or the second scheme, and the communication unit may transmit, to an infrastructure-side device, data stored in the decrypted packet.

In the above configuration, for example, even when communication between the vehicle and the infrastructure-side device is unstable or impossible, data of the vehicle can be uploaded to the infrastructure-side device as long as the other vehicle is communicable with the infrastructure-side device. Then, on the infrastructure side, the data of the vehicle can be analyzed in detail, which makes it possible to appropriately deal with malfunction or the like that may occur in the vehicle.
(9) An encrypted communication method according to the embodiment of the present disclosure is an encrypted communication method in an in-vehicle device to be mounted in a vehicle, and includes: generating first key deriving information according to a first scheme, generating first key information by using the first key deriving information, and encrypting a packet by using the first key information; transmitting the encrypted packet to another vehicle; and, after encrypting the packet by using the first key information, generating second key deriving information according to a second scheme that has a key information generating time shorter than that of the first scheme, generating second key information by using the second key deriving information, and encrypting a packet to be newly transmitted, by using the second key information instead of the first key information.

In the above configuration, since each vehicle generates key information and uses the key information for packet encryption, each vehicle need not use and manage, over a long period of time, unique keys stored therein in advance. Furthermore, for example, since an encryption scheme having rather high security is used first and then the scheme is switched to an encryption scheme having a short generation time, encrypted communication can be effectively performed according to the features of the respective schemes. Therefore, more satisfactory communication can be provided in the in-vehicle network.
(10) An encrypted communication program according to the embodiment of the present disclosure is an encrypted communication program used in an in-vehicle device to be mounted in a vehicle, and causes a computer to function as: a processing unit configured to generate first key deriving information according to a first scheme, generate first key information by using the first key deriving information, and encrypt a packet by using the first key information; and a communication unit configured to transmit the packet encrypted by the processing unit to another vehicle. After encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

In the above configuration, since each vehicle generates key information and uses the key information for packet encryption, each vehicle need not use and manage, over a long period of time, unique keys stored therein in advance. Furthermore, for example, since an encryption scheme having rather high security is used first and then the scheme is switched to an encryption scheme having a short generation time, encrypted communication can be effectively performed according to the features of the respective schemes. Therefore, more satisfactory communication can be provided in the in-vehicle network.

Hereinafter, an embodiment of the present disclosure will be described with reference to the drawings. In the drawings, the same or corresponding parts are denoted by the same reference signs, and descriptions thereof are not repeated. At least some parts of the embodiments described below may be combined together as desired.

[Configuration and Basic Operation]

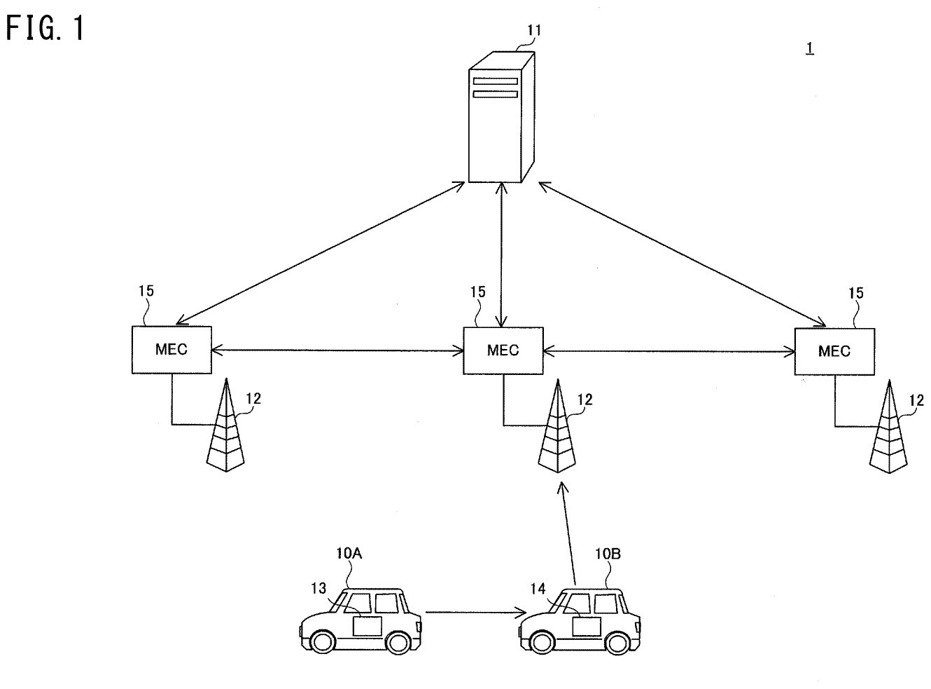

FIG. 1 shows a configuration of a vehicle management system according to an embodiment of the present disclosure.

With reference to FIG. 1, the vehicle management system 1 includes a server 11, infrastructure-side devices 12, an in-vehicle communication system 13 mounted in a vehicle 10A, an in-vehicle communication system 14 mounted in another vehicle 10B, and a plurality of MECs (Mobile Edge Computing) 15.

The vehicle management system 1 enables exchange of various data between the vehicles 10A, 10B and the server 11. For example, the vehicle management system 1 enables camera images, moving images, and the like captured in the vehicles 10A, 10B to be uploaded to the server 11. Furthermore, the vehicle management system 1 enables update programs for various types of software installed in the vehicles 10A, 10B to be transmitted from the server 11 to the vehicles 10A, 10B. In the present embodiment, a case where the vehicle 10A uploads log information including logs of various types of software in the vehicle 10A to the server 11 via the vehicle 10B, is assumed as an example.

The vehicle 10A transmits the log information to the vehicle 10B. The vehicle 10B transmits the log information received from the vehicle 10A, to an infrastructure-side device 12 that is close to the vehicle 10B or is in a good communication environment with respect to the vehicle 10B. The infrastructure-side device 12 is a wireless base station device, for example. The infrastructure-side device 12 transmits the log information received from the vehicle 10B to an MEC 15. The infrastructure-side device 12 may be a beacon. The infrastructure-side device 12 may include an MEC 15.

The MEC 15 analyzes the log information received from the infrastructure-side device 12, and shares the log information with another MEC 15. Furthermore, the respective MECs 15 mutually complement the log information. The MEC 15 acquires, for example, urgent information such as accident information from the log information, and outputs an alarm to the vehicles 10A, 10B. The MEC 15 may directly output the alarm to the vehicles 10A, 10B, or may output the alarm to the vehicle 10A via the vehicle 10B, or to the vehicle 10B via the vehicle 10A. Furthermore, the MEC 15 transmits the log information to the server 11.

The server 11 analyzes the log information received from the MEC 15 in more detail, and performs necessary processes.

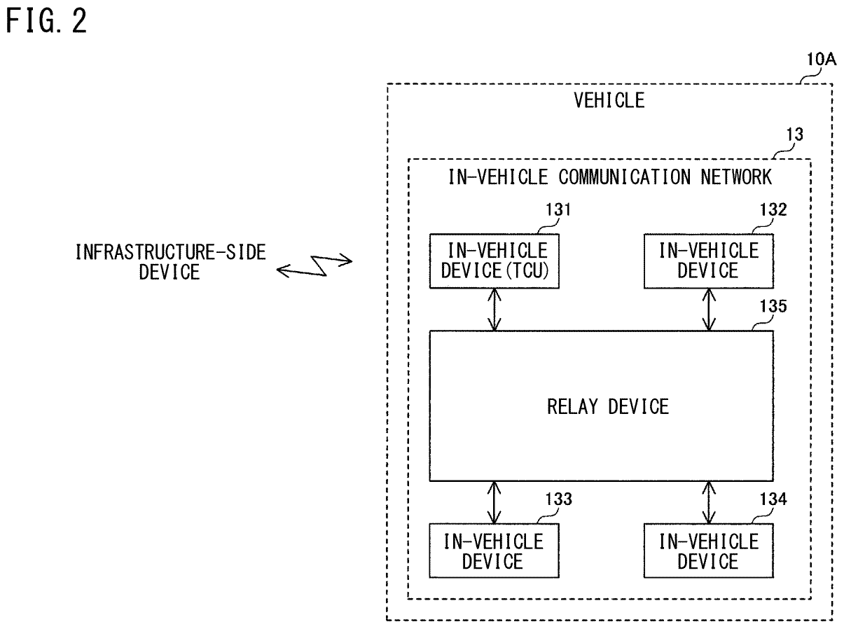

FIG. 2 shows a configuration of an in-vehicle communication system according to the embodiment of the present disclosure. FIG. 2 shows the configuration of the in-vehicle communication system 13 in the vehicle 10A as an example. The in-vehicle communication system 14 in the other vehicle 10B has the same configuration.

With reference to FIG. 2, the in-vehicle communication system 13 includes in-vehicle devices 131 to 134, and a relay device 135.

The in-vehicle communication system 13 may not necessarily include four in-vehicle devices 131 to 134, and may include three or fewer in-vehicle devices or five or more in-vehicle devices. The in-vehicle communication system 13 may not necessarily include one relay device 135, and may include two or more relay devices.

The in-vehicle device 131 is a TCU (Telematics Communication Unit), for example. Hereinafter, the in-vehicle device 131 is also referred to as a TCU 131.

The in-vehicle devices 133, 134 are, for example, any of an automated driving ECU (Electronic Control Unit), a sensor, a navigation device, a human machine interface, a camera, and the like. The in-vehicle device 132 will be described later.

In the in-vehicle communication system 13, the in-vehicle devices 131 to 134 are connected to the relay device 135 via Ethernet (registered trademark) cables.

The relay device 135 is a switch device, for example. The relay device 135 may be a gateway device. The relay device 135 performs an Ethernet frame relay process according to the Ethernet communication standard.

Specifically, the relay device 135 relays, for example, Ethernet frames that are exchanged between the in-vehicle devices 131 to 134. An Ethernet frame has an IP packet stored therein.

The in-vehicle communication system 13 may be configured to perform not only relay of Ethernet frames according to the Ethernet communication standard, but also relay of data according to communication standards such as CAN (Controller Area Network) (registered trademark), FlexRay (registered trademark), MOST (Media Oriented Systems Transport) (registered trademark), and LIN (Local Interconnect Network), for example.

With reference to FIG. 1 and FIG. 2, the TCU 131 can communicate with an infrastructure-side device 12. Specifically, the TCU 131 can communicate with the server 11 via the infrastructure-side device 12 according to an IP protocol, for example.

More specifically, the TCU 131 can wirelessly communicate with the infrastructure-side device 12 according to a communication standard such as LTE (Long Term Evolution) or 5G, for example.

Specifically, for example, upon receiving, from the infrastructure-side device 12, a radio frame in which an IP packet from an IP server is stored, the TCU 131 acquires the IP packet from the received radio frame, and stores the acquired IP packet in an Ethernet frame and transmits the Ethernet frame to the relay device 135.

Furthermore, upon receiving an Ethernet frame from the relay device 135, the TCU 131 acquires an IP packet from the received Ethernet frame, and stores the acquired IP packet in a radio frame and transmits the radio frame to the infrastructure-side device 12.

The TCU 131 can wirelessly communicate with the TCU in the other vehicle 10B through short-range wireless communication or the like, for example.

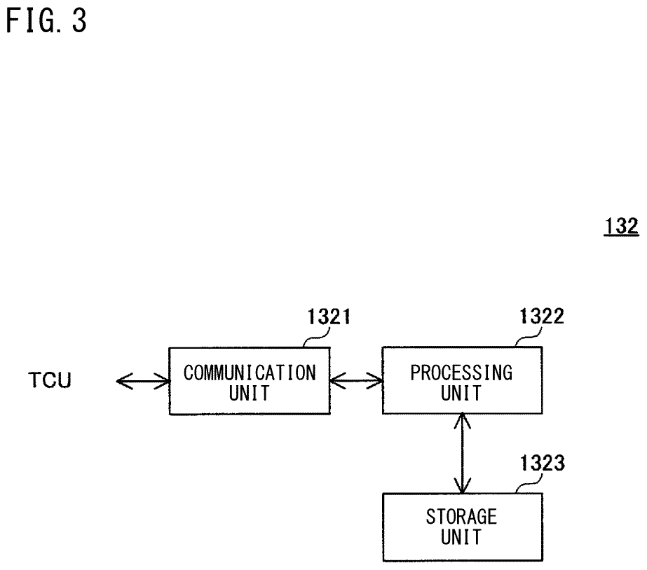

FIG. 3 shows a configuration of an in-vehicle device in the in-vehicle communication system according to the embodiment of the present disclosure. FIG. 3 shows the configuration of the in-vehicle device 132 in the vehicle 10A as an example.

With reference to FIG. 3, the in-vehicle device 132 includes a communication unit 1321, a processing unit 1322, and a storage unit 1323. The communication unit 1321 is implemented by a communication circuit such as a communication IC (Integrated Circuit), for example. The processing unit 1322 is implemented by a processor such as a CPU or a DSP (Digital Signal Processing), for example. The storage unit 1323 is anon-volatile memory, for example.

The communication unit 1321 exchanges data with the vehicle 10B and the infrastructure-side device 12 via the TCU 131. Furthermore, the communication unit 1321 exchanges data with the other in-vehicle devices 131, 133, 134 via the relay device 135.

The processing unit 1322 divides and stores data into a plurality of IP packets, and performs processes such as encryption and decryption for a data portion of each IP packet.

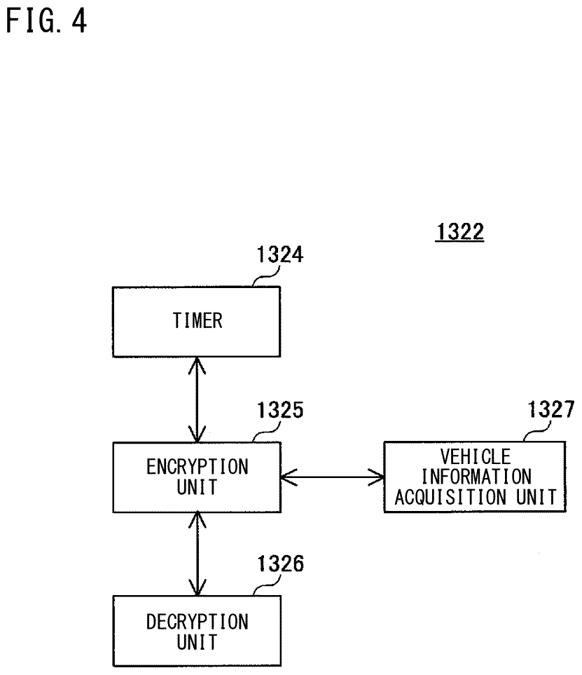

FIG. 4 shows a configuration of a processing unit in an in-vehicle device according to the embodiment of the present disclosure. FIG. 4 shows the configuration of the processing unit 1322 in the vehicle 10A as an example.

With reference to FIG. 4, the processing unit 1322 includes a timer 1324, an encryption unit 1325, a decryption unit 1326, and a vehicle information acquisition unit 1327.

The timer 1324 periodically stores, in the storage unit 1323, time information indicating the present time.

The vehicle information acquisition unit 1327 acquires information indicating the traveling state, such as the speed, of the vehicle 10A from another in-vehicle device via the relay device 135 and the communication unit 1321, and outputs the information to the encryption unit 1325.

The encryption unit 1325 receives the information indicating the traveling state from the vehicle information acquisition unit 1327. If this information satisfies a predetermined condition as described later, the encryption unit 1325 acquires the time information from the storage unit 1323, and encrypts the IP packet by using the time information and random numbers.

The decryption unit 1326 receives an encrypted IP packet from the other vehicle 10B via the TCU 131, the relay device 135, and the communication unit 1321, and decrypts this IP packet, as described later.

[Operation Flow]

Each of the devices in the vehicle management system 1 includes a computer. An arithmetic processing unit such as a CPU in the computer reads out a program including a part or all of steps in the sequence diagram or flowchart described below from a memory (not shown), and executes the program. The programs for the plurality of devices can be installed from outside. The programs for the plurality of devices are each distributed in a state of being stored in a storage medium.

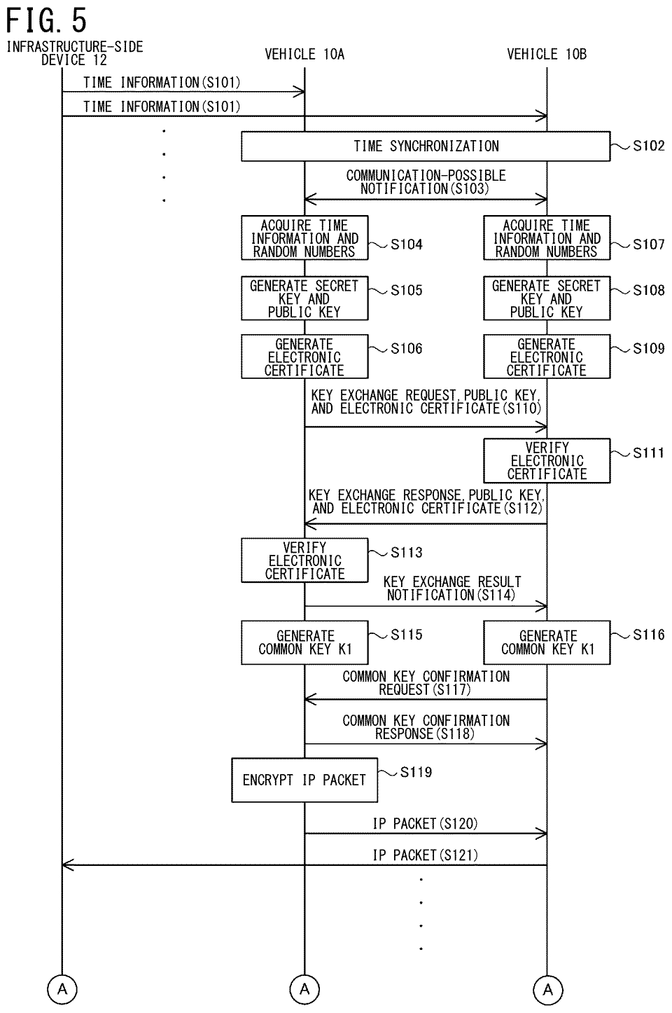

FIG. 5 shows a first half of a sequence indicating a process for encrypted communication in the vehicle management system according to the embodiment of the present disclosure.

With reference to FIG. 3 to FIG. 5, first, the infrastructure-side device 12 periodically transmits time information to the vehicle 10A and the other vehicle 10B (step S101).

Next, the vehicle 10A and the other vehicle 10B, each receiving the time information from the infrastructure-side device 12, perform time synchronization. The time synchronization adopts an NTP (Network Time Protocol), for example (step S102).

Next, each of the vehicle 10A and the other vehicle 10B periodically broadcasts a communication-possible notification indicating that a vehicle has entered a communicable range of the own vehicle. When the other vehicle 10B has entered the communicable range, the processing unit 1322 in the vehicle 10A receives a communication-possible notification from the other vehicle 10B via the TCU 131, the relay device 135, and the communication unit 1321 (step S103).

When the processing unit 1322 has received the communication-possible notification for the first time from the other vehicle 10B, the processing unit 1322, according to a first scheme, generates first key deriving information, and generates first key information by using the first key deriving information.

For example, the first scheme is an encryption scheme in which an encryption scheme using a secret key and a public key is combined with an encryption scheme using a common key.

More specifically, in the first scheme, the processing unit 1322 generates a pair of a secret key and a public key as first key deriving information by using the time information stored in the storage unit 1323 and random numbers. The processing unit 1322 stores the generated pair of the secret key and the public key into the storage unit 1323 (steps S104, S105).

Next, the processing unit 1322 generates an electronic certificate for the generated public key, and stores the electronic certificate in the storage unit 1323 (step S106).

Next, like the vehicle 10A, the processing unit 1322 in the other vehicle OB generates a pair of a secret key and a public key as first key deriving information by using the time information and random numbers, in the first scheme. In the other vehicle 10B, the processing unit 1322 generates an electronic certificate for the generated public key, and stores the electronic certificate in the storage unit 1323 (steps S107 to S109).

Next, the processing unit 1322 in the vehicle 10A transmits the public key and the electronic certificate stored in the storage unit 1323, to the other vehicle 10B via the communication unit 1321 and the TCU 131, together with a key exchange request (step S110).

Next, in the other vehicle 10B, the processing unit 1322 receives the public key, the electronic certificate, and the key exchange request from the vehicle 10A via the TCU 131 and the communication unit 1321, and verifies the electronic certificate (step S111).

Next, in the other vehicle 10B, the processing unit 1322 confirms that the received public key has been generated in the vehicle 10A, and transmits the generated public key and electronic certificate together with a key exchange response to the vehicle 10A via the communication unit 1321 and the TCU 131 (step S112).

Next, the processing unit 1322 in the vehicle 10A receives the public key, the electronic certificate, and the key exchange response from the other vehicle 10B via the TCU 131 and the communication unit 1321, and verifies the electronic certificate (step S113).

Next, the processing unit 1322 in the vehicle 10A confirms that the received public key has been generated in the other vehicle 10B, and transmits a key exchange result notification indicating this fact, to the other vehicle 10B via the communication unit 1321 and the TCU 131 (step S114).

Next, in the vehicle 10A, the processing unit 1322 generates a common key K1 as first key information by using the generated secret key and the public key received from the other vehicle 10B (step S115).

Next, as in the vehicle 10A, the processing unit 1322 in the other vehicle 10B receives the key exchange result notification from the vehicle 10A via the TCU 131 and the communication unit 1321, and generates a common key K1 by using the secret key generated in the other vehicle 10B and the public key received from the vehicle 10A (step S116).

Next, the processing unit 1322 in the other vehicle 10B, having generated the common key K1, transmits a common key confirmation request encrypted by using the common key K1, to the vehicle 10A via the communication unit 1321 and the TCU 131 (step S117).

Next, in the vehicle 10A, upon receiving the common key confirmation request via the TCU 131 and the communication unit 1321, the processing unit 1322 decrypts the received common key confirmation request by using the common key K1, and transmits a common key confirmation response to the other vehicle 10B via the communication unit 1321 and the TCU 131 (step S118).

Next, in the vehicle 10A, the processing unit 1322 encrypts an IP packet having data stored therein, by using the common key K1 as the first key information. More specifically, the processing unit 1322 divides and stores log information of various types of software installed in the in-vehicle devices 131, 133, 134 into a plurality of IP packets, for example. Then, the processing unit 1322 encrypts a data portion of each IP packet by using the common key K1, and outputs the IP packet to the communication unit 1321 (step S119).

Next, the communication unit 1321 in the vehicle 10A receives the encrypted IP packet from the processing unit 1322, and transmits the IP packet to the other vehicle 10B via the TCU 131 (step S120).

Next, in the other vehicle 10B, the processing unit 1322 receives the encrypted IP packet from the vehicle 10A via the TCU 131 and the communication unit 1321, and decrypts a data portion of the IP packet by using the common key K1. The processing unit 1322 transmits the IP packet in which a portion of log information acquired through the decryption is stored, to the infrastructure-side device 12 via the communication unit 1321 and the TCU 131. At this time, the processing unit 1322 encrypts the portion of the log information and transmits the IP packet to the infrastructure-side device 12. There is no limitation on the encryption scheme at this time, and a well-known encryption scheme may be adopted (step S121).

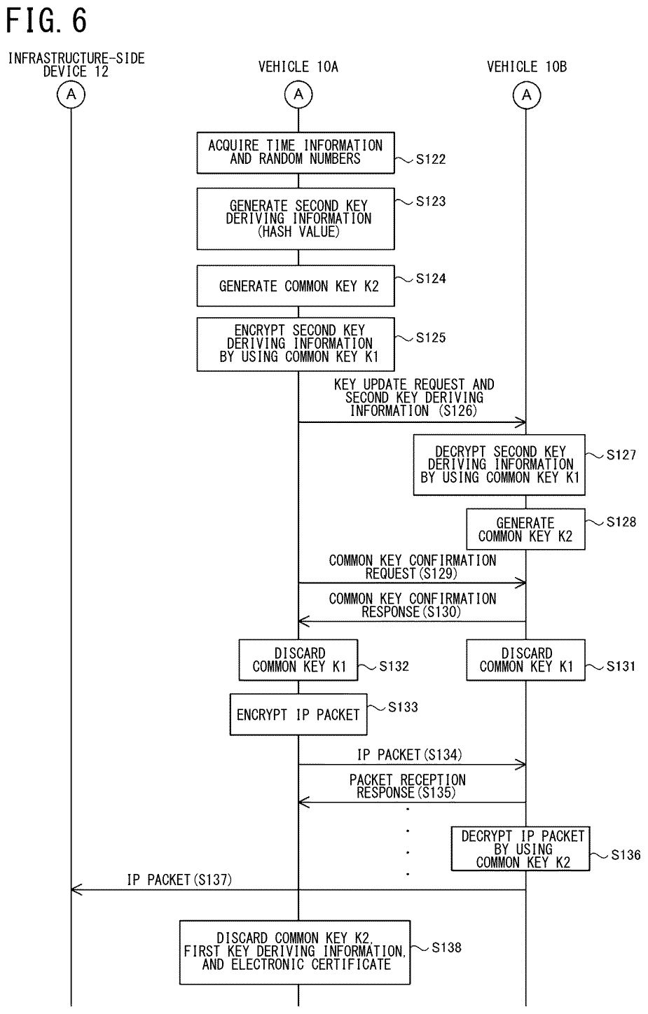

FIG. 6 shows a second half of the sequence indicating the process for encrypted communication in the vehicle management system according to the embodiment of the present disclosure.

With reference to FIG. 6, after the processing unit 1322 in the vehicle 10A has encrypted the IP packet by using first key information, if a first predetermined condition is satisfied, the processing unit 1322 generates second key deriving information according to a second scheme that has a key information generation time shorter than that of the first scheme, and generates second key information by using the second key deriving information. Then, by using the second key information instead of the first key information, the processing unit 1322 encrypts an IP packet in which a portion of log information is stored and which is newly transmitted by the communication unit 1321.

The first predetermined condition is a condition regarding, for example, an elapsed time, or a communication traffic with the other vehicle 10B from start of use of the first key information. More specifically, the condition regarding the elapsed time is, for example, that the duration of encrypted communication using the common key K1 becomes equal to or longer than a predetermined time period. The condition regarding the communication traffic is, for example, that the traffic of encrypted communication using the common key K1 becomes equal to or greater than a predetermined traffic.

However, the first predetermined condition is not limited to the above condition, and may be a condition regarding the traveling state of the vehicle 10A, for example. More specifically, this condition may be that a difference in speed or acceleration between the vehicle 10A and the other vehicle 10B becomes equal to or greater than a predetermined value.

The second scheme is an encryption scheme using a cryptographic hash function, for example.

More specifically, in the second scheme, the processing unit 1322 generates a hash value as second key deriving information by using a first cryptographic hash function, based on the time information stored in the storage unit 1323 and random numbers, and generates a common key K2 as second key information from the generated hash value by using a second cryptographic hash function (steps S122 to S124).

Next, the processing unit 1322 encrypts the hash value as the second key deriving information, by using the common key K1 as the first key information (step S125).

Next, the processing unit 1322 transmits the encrypted second key deriving information together with a key update request, to the other vehicle 10B via the communication unit 1321, the relay device 135, and the TCU 131 (step S126).

Next, the processing unit 1322 in the other vehicle 10B receives the key update request, and the hash value as the encrypted second key deriving information, from the vehicle 10A via the TCU 131, the relay device 135, and the communication unit 1321, and decrypts the hash value by using the common key K1 as the first key information (step S127).

Next, the processing unit 1322 in the other vehicle 10B generates a common key K2 from the hash value as the decrypted second key deriving information by using the second cryptographic hash function (step S128).

Next, after a predetermined time period has elapsed from when the encrypted second key deriving information was transmitted to the other vehicle 10B, the processing unit 1322 in the vehicle 10A transmits a common key confirmation request to the other vehicle 10B via the communication unit 1321, the relay device 135, and the TCU 131 (step S129).

Next, for example, when the processing unit 1322 in the other vehicle 10B has received the common key confirmation request from the vehicle 10A via the TCU 131, the relay device 135, and the communication unit 1321 and generation of the common key K2 has been completed, the processing unit 1322 switches the key information to be used for IP packet encryption, from the common key K1 to the common key K2. Then, the processing unit 1322 transmits a common key confirmation response to the vehicle 10A via the communication unit 1321, the relay device 135, and the TCU 131, and discards the common key K1 as the first key information (steps S130 and S131).

Next, the processing unit 1322 in the vehicle 10A receives the common key confirmation response from the other vehicle 10B via the TCU 131 and the communication unit 1321, and switches the key information to be used for IP packet encryption, from the common key K1 to the common key K2. Then, the processing unit 1322 discards the common key K1 as the first key information (step S132).

Next, for example, the processing unit 1322 in the vehicle 10A encrypts, by using the common key K2, a data portion of an IP packet in which a portion of the log information divided in step S119 in FIG. 5 is stored and which has not yet been transmitted to the other vehicle 10B, and outputs this IP packet to the communication unit 1321 (step S133).

Next, the communication unit 1321 in the vehicle 10A receives the encrypted IP packet from the processing unit 1322, and transmits the IP packet to the other vehicle 10B via the TCU 131 (step S134).

Next, in the other vehicle 10B, upon receiving the encrypted IP packet from the vehicle 10A via the TCU 131 and the communication unit 1321, the processing unit 1322 transmits a packet reception response to the vehicle 10A via the communication unit 1321 and the TCU 131, and decrypts a data portion of this IP packet by using the common key K2 (steps S135 and S136).

Next, the processing unit 1322 in the other vehicle 10B transmits a portion of log information acquired through the decryption, to the infrastructure-side device 12 via the communication unit 1321 and the TCU 131. At this time, the processing unit 1322 encrypts an IP packet in which the portion of the log information is stored, and transmits the encrypted IP packet to the infrastructure-side device 12. There is no limitation on the encryption scheme at this time, and a well-known encryption scheme may be adopted (step S137).

Next, when a second predetermined condition has been satisfied, the processing unit 1322 in the vehicle 10A generates new second key deriving information, according to the second scheme, and generates new second key information by using the new second key deriving information. Then, by using the new second key information, the processing unit 1322 encrypts an IP packet in which a portion of log information is stored and which is to be newly transmitted by the communication unit 1321. More specifically, for example, when a predetermined time period has elapsed from start of encrypted communication using the common key K2, the processing unit 1322 generates a new cryptographic hash function as second key deriving information by using time information and random numbers, generates a new common key K2 by using the generated cryptographic hash function, and starts encrypted communication with the other vehicle 10B by using the common key K2. After the start of the encrypted communication using the new common key K2, the processing unit 1322 discards the old common key K2. As described above, since the common key K2 is updated when the second predetermined condition has been satisfied, it is possible to ensure security even if the log information is increased because the state of the vehicle 10A is changed. The second predetermined condition is not limited to the predetermined elapsed time period from the start of the encrypted communication using the common key K2, and may be a condition regarding the traveling state of the vehicle 10A, for example.

As described above the processing unit 1322, in the second scheme, performs the encrypted communication while sequentially updating the second key information.

After the processing unit 1322 in the vehicle 10A has transmitted, to the other vehicle 10B, the IP packet encrypted by using the common key as the second key information, if a packet reception response from the other vehicle 10B does not arrive within a predetermined time period, the processing unit 1322 discards the common key as the second key information, the pair of the secret key and the public key as the first key deriving information, and the electronic certificate for the public key, and ends the encrypted communication with the other vehicle 10B (step S138).

The vehicle 10A may transmit log information of software in the other vehicle 10B to the infrastructure-side device 12. More specifically, in the other vehicle 10B, when the processing unit 1322 receives an encrypted IP packet from the vehicle 10A via the TCU 131 and the communication unit 1321, the processing unit 1322 may encrypt, by using the common key K1 or K2, an IP packet in which a portion of log information of various types of software installed in the in-vehicle devices in the other vehicle 10B is stored, and may transmit the IP packet together with a packet reception response to the vehicle 10A via the communication unit 1321 and the TCU 131. In this case, the processing unit 1322 in the vehicle 10A decrypts, by using the common key K1 or K2, the IP packet received via the TCU 131 and the communication unit 1321, and transmits the IP packet in which the portion of the log information of the other vehicle 10B, obtained through the decryption, is stored, to the infrastructure-side device 12.

During the encrypted communication using the common key K1 as the first key information, if the first predetermined condition is not satisfied within a predetermined time period, the vehicle 10A and the other vehicle 10B end the encrypted communication using the common key K1. More specifically, when the predetermined time period has elapsed from when the vehicle 10A and the other vehicle 10B started to use the common key K1 and the first predetermined condition is not satisfied, the vehicle 10A and the other vehicle 10B discard the common key K1 to end the encrypted communication. However, regardless of a lapse of time, the vehicle 10A and the other vehicle 10B may end the encrypted communication using the common key K1 when traveling of one of the vehicles has ended or when an ignition or a power supply has been turned off, for example.

The other vehicle 10B may not necessarily be configured to switch the key information to be used for IP packet encryption, from the common key K1 to the common key K2, when the vehicle 10B has received a common key confirmation request from the vehicle 10A and has completed generation of the common key K2. The other vehicle 10B may switch the key information to be used for IP packet encryption, from the common key K1 to the common key K2, when receiving, from the vehicle 10A, an Ethernet frame including a specific content such as a flag, for example. In this case, for example, the vehicle 10A switches the key information to be used for IP packet encryption, from the common key K1 to the common key K2, when transmitting the Ethernet frame including the specific content.

Meanwhile, data such as log information of various types of software of a vehicle is stored in an EDR (Event Data Recorder) mounted in the vehicle, for example. However, there is a limitation on the capacity of the EDR, which limits the amount of log information that can be stored in the EDR. Therefore, in order to collect more data, it is conceivable to upload the log information of the vehicle to the server as required. In this case, since the vehicle and the server exchange the data through wireless communication, the data needs to be encrypted.

However, when a vehicle desires to perform encrypted communication with other equipment such as a server, information required for encryption, such as an electronic certificate, an encryption key, etc., obtained from an external system such as a certificate authority, a key generation authority, etc., needs to be stored in the vehicle in advance and managed. Management of information required for encryption is performed by each vehicle, and therefore is complicated and made difficult with an increase in the number of vehicles.

Meanwhile, in the vehicle management system, the in-vehicle device, the encrypted communication method, and the encrypted communication program according to the present embodiment, a vehicle generates common keys K1, K2 and uses the keys for encryption of an IP packet having data stored therein. The common keys K1, K2 are discarded when a predetermined time period has elapsed or when wireless connection has been disconnected. Thereafter, when an IP packet is uploaded to the server 11 again, a new common key is generated and used for encryption of the IP packet. Thus, since the common keys K1, K2 to be used for IP packet encryption are generated in each vehicle as time-limit type keys that are used for only a specific period of time, each vehicle need not use and manage, over a long period of time, unique keys stored therein in advance. Since the time-limit type common keys are used, even if encrypted communication using the common keys K1, K2 is intercepted and decrypted, common keys different from the common keys K1, K2 are used for subsequent encrypted communication. Therefore, it is possible to reduce the risk that the subsequent encrypted communication is decrypted again by the decryption method for the previous encrypted communication. Therefore, more satisfactory communication can be provided in the in-vehicle network.

When the vehicle 10A communicates with the infrastructure-side device 12 by using a standard such as LTE or 5G, the communication may become unstable depending on the position, communication environment, or the like of the vehicle 10A, which may make upload of data to the server 11 difficult.

Meanwhile, in the vehicle management system, the in-vehicle device, the encrypted communication method, and the encrypted communication program according to the present embodiment, the vehicle 10A uploads data to the server 11 via the other vehicle 10B and the infrastructure-side device 12. Therefore, even when communication between the vehicle 10A and the infrastructure-side device 12 is unstable or impossible, log information of the vehicle 10A can be uploaded to the server 11 as long as the other vehicle 10B is communicable with the infrastructure-side device 12. Therefore, more satisfactory communication can be provided in the in-vehicle network.

Generally, encrypted communication using a common key has a risk that encryption is decrypted if the common key is known by the third party when it is passed to a communication partner. Meanwhile, in encrypted communication using a pair of a secret key and a public key, only the public key is passed to a communication partner, and the risk of decryption is low even if the public key is known by the third party. Therefore, it is desirable for vehicle-to-vehicle communication to adopt encrypted communication using a pair of a secret key and a public key.

However, generation of a pair of a secret key and a public key requires many processes and takes a long time. Since vehicles are movable bodies, vehicle-to-vehicle communication may be unintentionally disconnected due to a distance between vehicles, obstacles, etc. Therefore, in vehicle-to-vehicle communication, the quicker the keys are generated, the better.

Meanwhile, in the vehicle management system, the in-vehicle device, the encrypted communication method, and the encrypted communication program according to the present embodiment, each of the vehicles 10A, 10B first generates a common key K1 by using a pair of a secret key and a public key as the first scheme, thereafter, generates a common key K2 using a cryptographic hash function as the second scheme, and uses the common key K2 for encryption. The common key K2 using the cryptographic hash function can be generated more quickly than the pair of the secret key and the public key. Therefore, an IP packet can be encrypted in a short time, whereby more encrypted IP packets can be exchanged in vehicle-to-vehicle communication. Therefore, more satisfactory communication can be provided in the in-vehicle network.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the feature in the additional note below.

[Additional Note 1]

An in-vehicle device to be mounted in a vehicle, comprising:
a processing unit configured to generate first key deriving information according to a first scheme, generate first key information by using the first key deriving information, and encrypt a packet by using the first key information; and
a communication unit configured to transmit the packet encrypted by the processing unit to another vehicle, wherein
the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information, and
when a second predetermined condition has been satisfied, the processing unit generates new second key deriving information according to the second scheme, generates new second key information by using the new second key deriving information, and uses the new second key information for encryption of a packet to be newly transmitted by the communication unit.

### REFERENCE SIGNS LIST

1 vehicle management system
10A vehicle
10B another vehicle
11 server
12 infrastructure-side device
13 in-vehicle communication system
131 to 134 in-vehicle device
1321 communication unit
1322 processing unit
1323 storage unit
1324 timer
1325 encryption unit
1326 decryption unit
1327 vehicle information acquisition unit
135 relay device
14 in-vehicle communication system (another vehicle)
15 MEC

1. An in-vehicle device to be mounted in a vehicle, comprising:
a processing unit configured to generate first key deriving information according to a first scheme, generate first key information by using the first key deriving information, and encrypt a packet by using the first key information; and
a communication unit configured to transmit the packet encrypted by the processing unit to another vehicle, wherein
after encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.

2. The in-vehicle device according to claim 1, wherein
the processing unit encrypts the second key deriving information by using the first key information, and
the communication unit transmits, to the other vehicle, the second key deriving information encrypted by the processing unit.

3. The in-vehicle device according to claim 1, wherein
in the first scheme, the processing unit generates a pair of a secret key and a public key as the first key deriving information, and generates a common key as the first key information by using the pair,
in the second scheme, the processing unit generates a hash value as the second key deriving information by using a first cryptographic hash function, and generates a common key from the hash value by using a second cryptographic hash function, and
the communication unit transmits, to the other vehicle, the hash value generated by the processing unit.

4. The in-vehicle device according to claim 1, wherein
when a predetermined condition has been satisfied, the processing unit generates the second key information, and uses the second key information, instead of the first key information, for encryption of a packet to be newly transmitted by the communication unit, and
the predetermined condition is a condition regarding an elapsed time, or communication traffic with the other vehicle from start of use of the first key information.

5. The in-vehicle device according to claim 1, wherein
when a predetermined condition has been satisfied, the processing unit generates the second key information, and uses the second key information, instead of the first key information, for encryption of a packet to be newly transmitted by the communication unit, and
the predetermined condition is a condition regarding a traveling state of the vehicle.

6. The in-vehicle device according to claim 1, wherein
the processing unit updates the second key information.

7. The in-vehicle device according to claim 1, wherein
in at least one of the first scheme and the second scheme, the processing unit uses time information and random numbers for generation of key deriving information.

8. The in-vehicle device according to claim 1, wherein
the processing unit decrypts an encrypted packet received from the other vehicle, according to the first scheme or the second scheme, and
the communication unit transmits, to an infrastructure-side device, data stored in the decrypted packet.

9. An encrypted communication method in an in-vehicle device to be mounted in a vehicle, the method comprising:
generating first key deriving information according to a first scheme, generating first key information by using the first key deriving information, and encrypting a packet by using the first key information;
transmitting the encrypted packet to another vehicle; and
after encrypting the packet by using the first key information, generating second key deriving information according to a second scheme that has a key information generating time shorter than that of the first scheme, generating second key information by using the second key deriving information, and encrypting a packet to be newly transmitted, by using the second key information instead of the first key information.

10. A non-transitory computer-readable storage medium having, stored therein, a encrypted communication program used in an in-vehicle device to be mounted in a vehicle, the program causing a computer to function as:
a processing unit configured to generate first key deriving information according to a first scheme, generate first key information by using the first key deriving information, and encrypt a packet by using the first key information; and
a communication unit configured to transmit the packet encrypted by the processing unit to another vehicle, wherein
after encrypting the packet by using the first key information, the processing unit generates second key deriving information according to a second scheme that has a key information generating time shorter than that of the first scheme, generates second key information by using the second key deriving information, and encrypts a packet to be newly transmitted by the communication unit, by using the second key information instead of the first key information.
